(19) United States
(12) Patent Application Publication
(10) Pub. No.: US 2017/0362825 A1
(43) Pub. Date: Dec. 21, 2017

(54) A Slatted Screen

(71) Applicant: Gram Engineering Pty Ltd., Smithfield (AU)

(72) Inventor: Ronald Leslie Mann, Smithfield (AU)

(73) Assignee: Gram Engineering Pty Ltd, Smithfield (AU)

(21) Appl. No.: 15/538,937

(22) PCT Filed: Dec. 31, 2015
(86) PCT No.: PCT/AU2015/050852

§ 371 Date: Jun. 22, 2017

(30) Foreign Application Priority Data
Dec. 31, 2014 (AU) 2014905309

(51) Int. Cl. E04B 2/74; E04H 17/14; E06B 9/24

(52) U.S. Cl. CPC E04B 2/7433; E06B 9/24; E04H 17/1413; E04B 2002/7446; E04B 2002/7461; E04H 2017/1465

(57) ABSTRACT

Disclosed herein is a slatted screen 10 comprising a frame comprising first and second opposite side members 12 and first and second opposite end members 14. A plurality of slats 18 extend between the side members 12. The slats 18 lie in a common plane P and comprise a first and second end slats 18a at opposite ends of a plurality of intermediate slats 18b. The intermediate slats 18b comprise a first group of slats 18b₁ and a second group of slats 18b₂, wherein the slats of the two groups are interspersed with each other. The slats 18b₁ of the first group are angled relative to the common plane P at different angle to the slats 18b₂ of the second group.

### PRIORITY

The present application is a U.S. National Stage patent application of International Application No. PCT/AU2015/050852, filed on Dec. 31, 2015, which claims priority to Australian Patent Application No. 2014905309, filed on Dec. 31, 2014, the disclosures of which are hereby incorporated by reference in their entirety.

### TECHNICAL FIELD

The present disclosure relates to a slatted screen. The screen has been developed primarily for outdoor use in fencing, as a partition, or to form an aesthetically pleasing enclosure to conceal various items, such as hot water storage tanks, air conditioning outdoor units, and the like, and will be described hereinafter with reference to this application. However, it will be appreciated that the presently disclosed screen is not limited to these uses and may also be used indoors or for other purposes.

### BACKGROUND

Typically, a slatted screen comprises a frame with a plurality of slats connected thereto. The slats are provided in spaced apart parallel relationship to one another and lie in a common plane. The slats have a fixed angle of inclination, as distinct from the blades of adjustable louvres or blinds, which have a variable angle of inclination. Most commonly, the slats have a zero degree angle of inclination with respect to their common plane. However, in some screens, the slats are angled relative to the plane at a common angle of inclination.

A disadvantage of such known screens is that they have a very uniform appearance in terms of geometry and shadow. The screens also exhibit very uniform colour unless different components of the screen are provided in different colours. Some people consider this uniformity aesthetically unappealing and lacking in character.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Disclosed herein is a slatted screen comprising:

a frame for holding a plurality of slats in spaced apart relationship to one another with their longitudinal axes parallel and with a fixed angle of inclination;

a plurality of slats held by the frame in spaced apart parallel to one another with their longitudinal axes parallel and with a fixed angle of inclination, the slats lying in a common plane and comprising a first end slat at a first end of the plurality of slats, a second end slat at an opposite second end of the plurality of slats, and intermediate slats between the end slats,

wherein the intermediate slats comprise at least two groups of one or more slats, wherein the slats of the groups are interspersed with each other, and wherein the slats of each group are angled relative to the common plane at different angle to the slats of the other group(s).

The difference between the angles at which each of the groups of slats is angled relative to the common plane may be at least 5 degrees, at least 10 degrees, at least 15 degrees, at least 20 degrees, at least 25 degrees, at least 30 degrees, at least 35 degrees, at least 40 degrees, at least 45 degrees, at least 50 degrees, at least 55 degrees, at least 60 degrees, at least 65 degrees, at least 70 degrees, at least 75 degrees, at least 80 degrees, at least 85 degrees or at least 90 degrees. The angles at which each of the groups of slats is angled relative to the common plane may be opposite in sign or of the same sign.

The first end slat may be angled relative to the common plane at the same angle as one of the groups of slats. The second end slat may be angled relative to the common plane at the same angle as one of the groups of slats.

The frame may be rectangular, comprising opposite end members and opposite side members. The slats may extend between the opposite side members and the opposite side members may comprise brackets or openings or otherwise be configured to secure ends of the slats. One or more intermediate struts may extend between the end members. The intermediate struts may comprise brackets or openings or otherwise be configured to secure intermediate portions of the slats.

### BRIEF DESCRIPTION OF DRAWINGS

An embodiment of the presently disclosed slatted screen will now be described, by way of example only, with reference to the accompanying drawings, in which:

FIG. 1 is a perspective view of an embodiment of a slatted screen according to the present disclosure;

FIG. 2 is a cross sectional view taken along line 2-2 of FIG. 1;

FIG. 3 is a perspective view of a side member of the screen of FIG. 1; and

FIG. 4 is a perspective view of an intermediate strut of the screen of FIG. 1.

### DESCRIPTION OF EMBODIMENTS

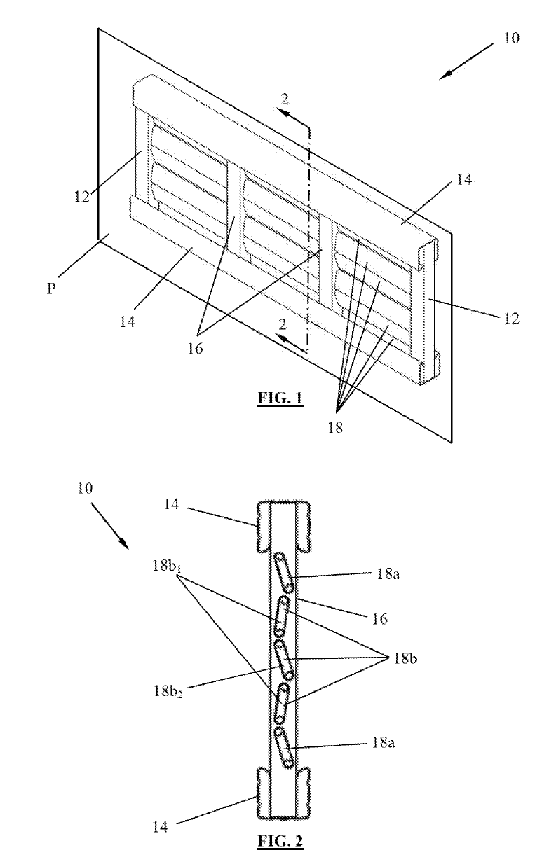

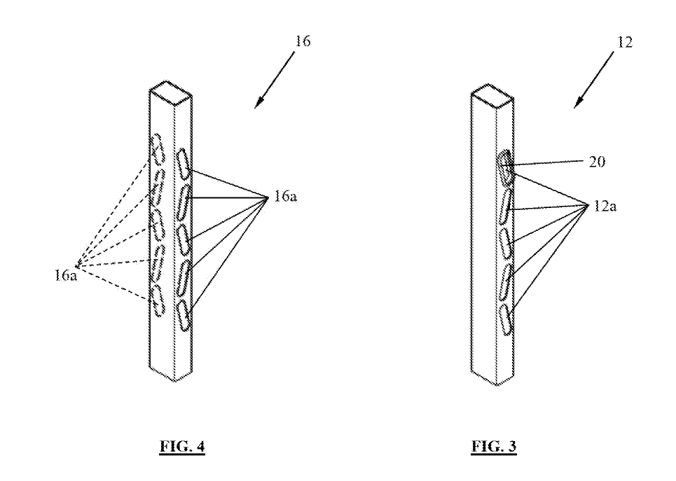

Referring to FIGS. 1 to 4, there is shown a slatted screen 10 comprising a frame comprising first and second opposite side members 12 and first and second opposite end members 14. Depending on the distance between the side members 12, one or more intermediate struts 16 may be provided therebetween, with opposite ends of the struts being connected to the end members 14. A plurality of slats 18 extend between the side members 12.

The slats 18 lie in a common plane P and comprise a first and second end slats 18a at opposite ends of a plurality of intermediate slats 18b. The intermediate slats 18b comprise a first group of slats 18b₁ and a second group of slats 18b₂, wherein the slats of the two groups are interspersed with each other. The slats 18b₁ of the first group are angled relative to the common plane P at different angle to the slats 18b₂ of the second group, such that the difference between the angles at which each group of slats is angled relative to the common plane is at least 5 degrees. In the illustrated embodiment, the slats 18b₁ are angled at around −15 degrees and the slats 18b₂ are angled at around +15 degrees, such that the difference between the angles is around 30 degrees.

In the illustrated embodiment, the end slats 18a are angled relative to the common plane at the same angle as one of the groups of intermediate slats 18b. However, in other embodiments, the end slats 18a may be angled relative to the common plane P at a different angle to the groups of intermediate slats 18b, such as at zero degrees relative to the common plane P (i.e., the end slats 18b may be parallel to the common plane).

The side members 12 comprise openings 12a to secure ends of the slats 18. Similarly, the intermediate struts 16 comprise openings 16a to secure intermediate potions of the slats 18. Engagement of the slats 18 with the openings 12a, 16a of the side members and struts holds the slats in spaced apart relationship to one another, with their longitudinal axes A parallel, and with a fixed angle of inclination corresponding with their respective angling relative to the common plane P.

In the illustrated embodiment, the side members 12 and struts 16 are formed from steel and spacers, in the form of collars 20 formed from plastics material, are provided in each of the openings 12a, 16a to space the slats 18 from the side members 12 and struts 16 to protect the slats 18 against being scratched by the side members 12 and struts 16 and to inhibit rattling of the slats in the openings 12a, 16a.

In the illustrated embodiment, the side members 12 are formed from a length of box-section and the end members 14 are formed from channel-section. The dimensions of the box-section are such that the ends of the side members 12 fit snugly in the channels of the end members 14.

It will be appreciated that the differently angled slats 18 of the illustrated embodiment advantageously provide a screen 10 that exhibits variation in terms of geometry and shadow. Even if all of the slats 18 are of the same colour, the differently angled slats 18 also give the screen 10 the appearance of having slight variations in slat colour or tone. These variations in geometry, shadow and colour/tone add to the character of the screen 10.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. Examples of possible variations and/or modifications include, but are not limited to:
the openings 12a, 16a being omitted and the side members 12 and intermediate struts 16 instead being provided with brackets or clips, or otherwise being configured for securing the slats 18;
the intermediate struts 16 being omitted, especially in screens wherein the spacing between the side members 12 is relatively small;
the different groups of intermediate slats 18b may be angled at other fixed angles relative to the common plane P, provided that the difference between the angles of the slats of the different groups is at least 5 degrees;
whilst in the illustrated embodiment the angles of both groups of intermediate slats 18b relative to the common plane P are of opposite sign, in other embodiments the angles may be of the same sign;
more than two groups of intermediate slats 18b may be provided, with the slats of the different groups being interspersed with each other, and wherein the slats of each group are angled relative to the common plane P at a different angle to the slats of the other groups, wherein the difference in the angles between the slats of the different groups is at least 5 degrees, such as about 30 degrees;
the side members 12 and struts 16 may be formed from any other suitable material, such as aluminium or another metal, or from a plastics material;
the spacers 20 may be omitted, especially if the side members 12 and struts 16 are formed from a material that is unlikely to scratch the slats 18; and/or
rather than openings 12a being provided in the side members 12, the side members may be formed from channel section similar to that used for the illustrated end members 14, and box-section struts, of corresponding shape to and with openings 12a as in the illustrated side members 12, may be located in the channels of the side members.

1. A slatted screen comprising:
a frame for holding a plurality of slats in spaced apart relationship to one another with their longitudinal axes parallel and with a fixed angle of inclination;
a plurality of slats held by the frame in spaced apart parallel to one another with their longitudinal axes parallel and with a fixed angle of inclination, the slats lying in a common plane and comprising a first end slat at a first end of the plurality of slats, a second end slat at an opposite second end of the plurality of slats, and intermediate slats between the end slats,
wherein the intermediate slats comprise at least two groups of one or more slats, wherein the slats of the groups are interspersed with each other, and wherein the slats of each group are angled relative to the common plane at different angle to the slats of the other group(s).

2. The slatted screen according to claim 1, wherein the difference between the angles at which each of the groups of slats is angled relative to the common plane is at least 5 degrees.

3. The slatted screen according to claim 1, wherein the difference between the angles at which each of the groups of slats is angled relative to the common plane is at least 10 degrees.

4. The slatted screen according to claim 1, wherein the difference between the angles at which each of the groups of slats is angled relative to the common plane is at least 15 degrees.

5. The slatted screen according to claim 1, wherein the difference between the angles at which each of the groups of slats is angled relative to the common plane is at least 20 degrees.

6. The slatted screen according to claim 1, wherein the difference between the angles at which each of the groups of slats is angled relative to the common plane is at least 25 degrees.

7. The slatted screen according to claim 1, wherein the difference between the angles at which each of the groups of slats is angled relative to the common plane is at least 30 degrees.

8. The slatted screen according to claim 1, wherein the difference between the angles at which each of the groups of slats is angled relative to the common plane is at least 45 degrees.

9. The slatted screen according to claim 1, wherein the difference between the angles at which each of the groups of slats is angled relative to the common plane is at least 60 degrees.

10. The slatted screen according to claim 1, wherein the difference between the angles at which each of the groups of slats is angled relative to the common plane is at least 75 degrees.

11. The slatted screen according to claim 1, wherein the difference between the angles at which each of the groups of slats is angled relative to the common plane is at least 90 degrees.

12. The slatted screen according to claim 1, wherein the first end slat is angled relative to the common plane at the same angle as one of the groups of slats.

13. The slatted screen according to claim 1, wherein the second end slat is angled relative to the common plane at the same angle as one of the groups of slats.

14. The slatted screen according to claim 1, wherein the frame is rectangular, comprising opposite end members and opposite side members, and wherein the slats extend between the opposite side members, and wherein the opposite side members comprise brackets or openings or are otherwise configured to secure ends of the slats.

15. The slatted screen according to claim 14, comprising one or more intermediate struts extending between the end members, the intermediate struts comprising brackets or openings or otherwise being configured to secure intermediate portions of the slats.
